(19) United States
(12) Patent Application Publication
(10) Pub. No.: US 2008/0014544 A1
(43) Pub. Date: Jan. 17, 2008

(54) Orthodontic Bracket Having Friction Control Means

(76) Inventor: Riccardo Nucera, Giardini-Naxos (Messina) (IT)

Correspondence Address: YOUNG & THOMPSON, 745 SOUTH 23RD STREET, 2ND FLOOR, ARLINGTON, VA, 22202, US

(21) Appl. No.: 11/662,936

(22) PCT Filed: Sep. 16, 2005
(86) PCT No.: PCT/IT05/00528

§ 371 Date: Mar. 16, 2007

(30) Foreign Application Priority Data
Sep. 16, 2004 (IT) ME2004A000007

(51) Int. Cl. A61C 7/28

(52) U.S. Cl. 433/13; 433/8

(57) ABSTRACT

An orthodontic bracket (1) includes a bracket base (2) able to be secured to the face of a tooth, a body (3) secured to the bracket base (2) and provided with a recess or through slot (4) able to receive an orthodontic wire, and tightening elements (8) to block the orthodontic wire within the slot (4) is characterized in that the tightening element (8) is able to perform its function with controlled intensity varying between a maximum value at which the orthodontic wire is blocked within the slot (4) and a minimum value at which the orthodontic wire is completely free to slide within the slot (4).

The present invention relates to dentistry, and more particularly a device for the orthodontic therapy able to adjust the friction between wire and bracket.

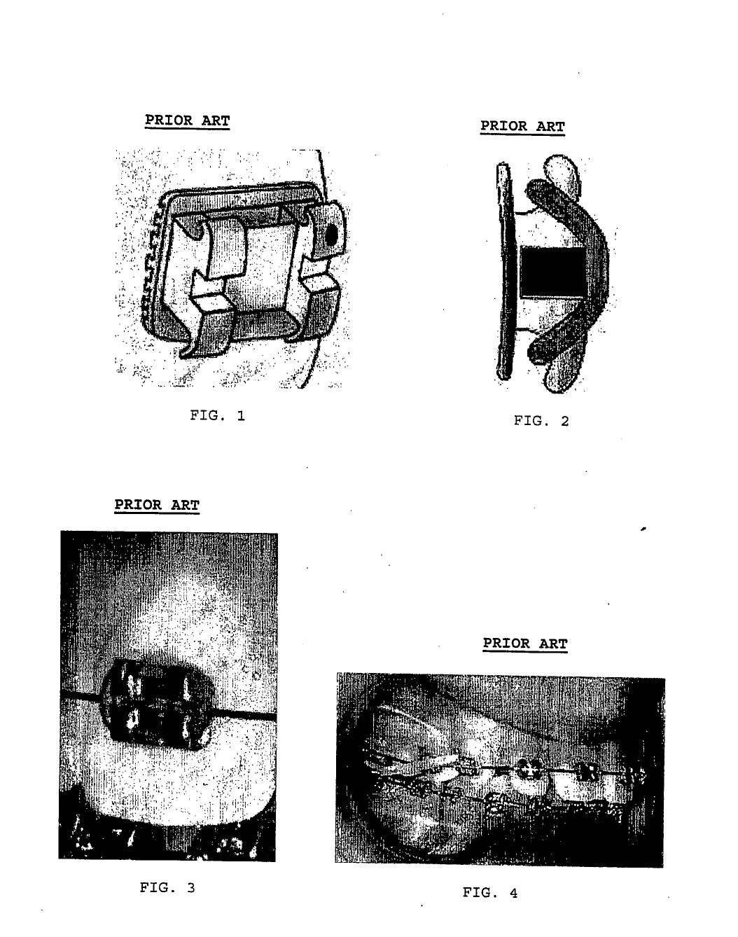

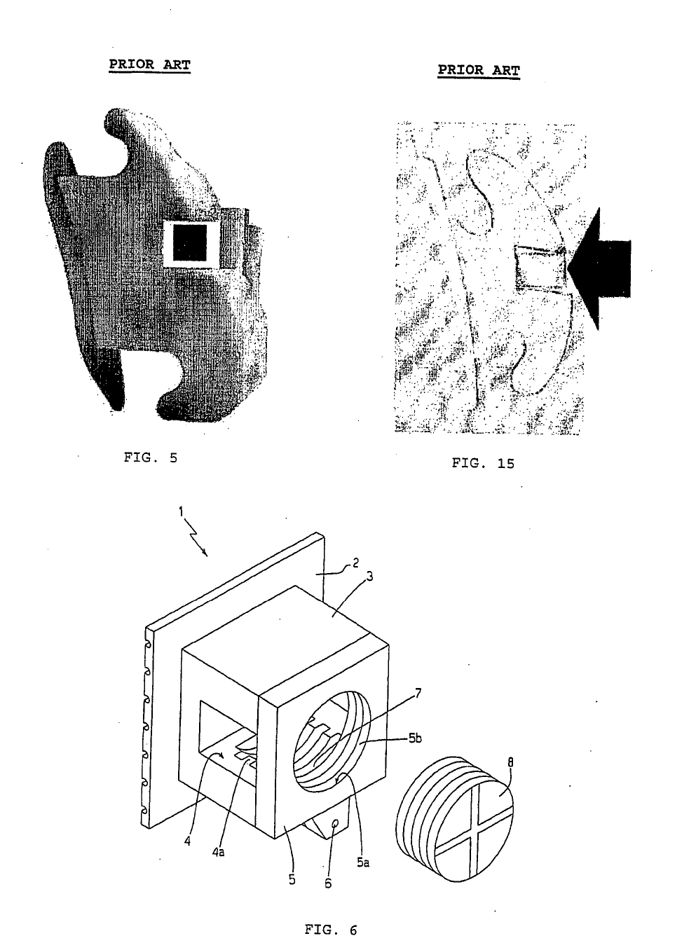

The treatment of the dental malocclusions is made by the medical specialist in orthodontics through biomechanical devices that are either secured (brackets) to the dental elements or can be removed (orthodontic wires) by the doctor. The wire is received by the bracket in a space or slot having the shape of a parallelepiped (FIG. 1). The brackets are glued to the outside surface of all teeth of the dental arch. They allow the forces applied during the orthodontic therapy to be transferred to the teeth. In the “straight wire” orthodontics the orthodontic wire enters the slot of each bracket, and the teeth are displaced to the direction of the orthodontic wire. Springs and/or elastic means can be applied to the brackets to displace the teeth. As a tooth moves, the bracket slides to the direction of the orthodontic wire (FIG. 4).

The connecting means (ligature) by which the orthodontic wire is tied to the bracket influences significantly the amount of friction between wire and bracket. Conventional (elastic and metallic) ligatures induce a squeezing of the wire against the bottom of the slot and as a result also a certain amount of friction (FIGS. 2 and 3). The friction produced opposes the displacement of the tooth. The passive self-binding bracket (FIG. 5) holds the orthodontic wire inside the slot without squeezing it against the bottom of the slot. Its failing in squeezing reduces the friction between wire and bracket and allows weaker forces to be applied, thus facilitating the control of the desired displacement of the tooth.

The object of the present invention is an orthodontic bracket as set forth in claim 1.

A better understanding of the present invention will result from the following description with reference to the accompanying drawings that show a preferred embodiments thereof only by way of a not limiting example.

In the drawings:

FIGS. 1 to 5 and FIG. 15 show orthodontic brackets of the prior art;

FIG. 6 is a perspective view showing schematically an orthodontic bracket according to the present invention;

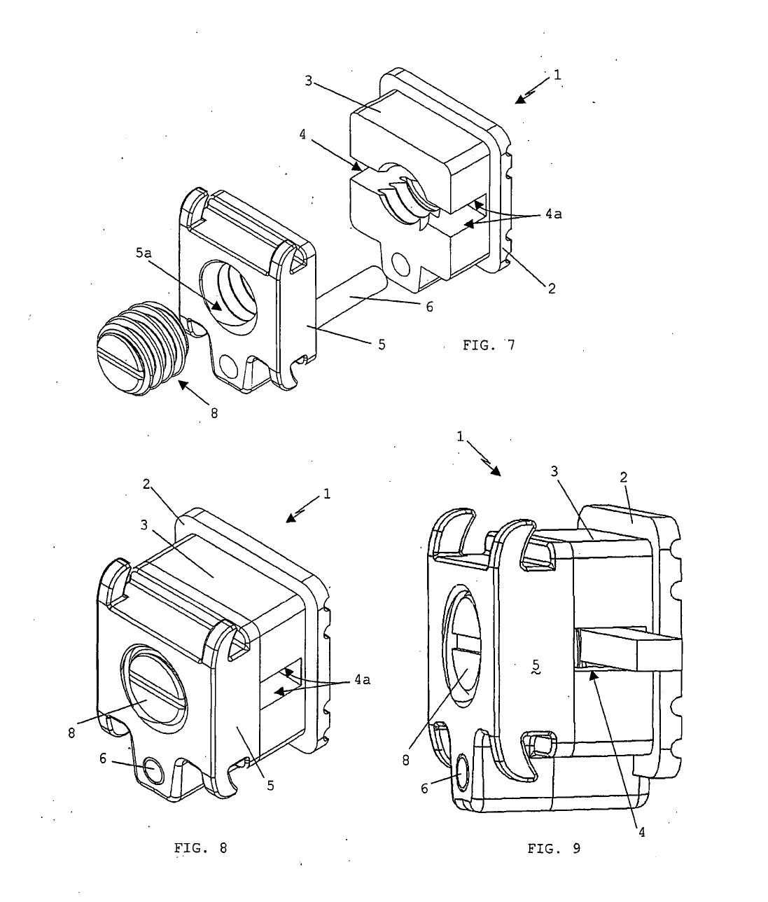

FIG. 7 is an exploded perspective view of a preferred embodiment of orthodontic bracket of FIG. 6;

FIG. 8 is a perspective view showing the bracket of FIG. 6 in assembled condition;

FIG. 9, similar to the preceding figure, shows the finding with the orthodontic bracket tightened by the screw;

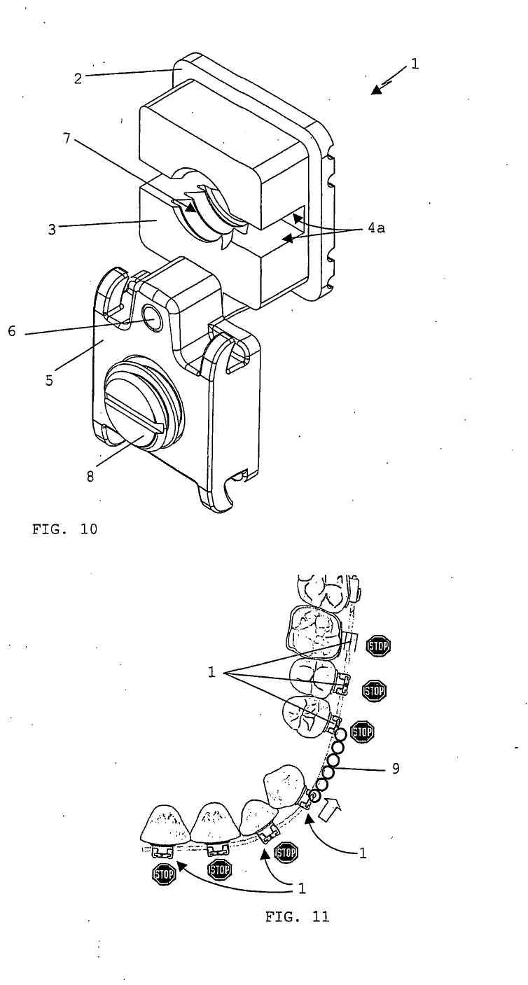

FIG. 10 is a perspective view of the bracket of FIG. 8 in opened condition to allow the orthodontic wire to be inserted/extracted;

FIGS. 11-13 show schematically some embodiments of the finding to displace the teeth; and

FIG. 14 shows schematically an embodiment of the invention to cause a tooth to rotate or to undergo a torque.

With reference to FIGS. 6 to 10, an orthodontic bracket according to the present invention is generally indicated at 1.

The disclosed orthodontic bracket 1 includes a bracket base 2 able to be secured to the tooth face, which bracket base 2 is integral with a body 3 provided with a recess or slot 4 which has an essentially flat bottom and is inclined with respect to bracket base 2, such inclination, in the so-called brackets with “torque applied to the base”, depending on the vestibular-lingual inclination (anterior-posterior inclination for the front teeth) that is usually taken by the root of the tooth to which the bracket is applied.

It should be appreciated that upper incisors have a greater torque than lower incisors where the bottom of the slot is generally parallel to bracket base 2.

Such slot 4 is able to receive an orthodontic wire of the known type. Body 3 of bracket 1 includes a pivotable vestibular wall 5 which is hinged to the body by a side pin 6 and is provided with a central hole 5a. A screw thread 7 is formed at the inner side surfaces 4a of through slot 4 and surface 5b of central hole 5a.

In the embodiment shown, pin 6 is generally perpendicular to bracket base 2 so that pivotable wall 5 can turn upon such pin with respect to body 3.

According to a peculiar feature of the finding the disclosed orthodontic bracket 1 includes a screw 8 able to hold and/or tighten an orthodontic wire in through slot 4 by the engagement with screw thread 7.

Screw 8, which is an absolutely innovative, original means for an orthodontic bracket, allows advantageously the friction produced between wire and bracket, i.e. the friction force opposing their relative displacement, to be adjusted. In fact, if such screw is not completely screwed into the slot, the orthodontic wire can slide within the latter with a reduced friction; instead, as the screw is farther screwed or tightened, the wire will be squeezed against the bottom of the slot and as a result the friction force opposing the relative displacements between bracket and wire will increase, thus preventing the wire from being displaced within the bracket slot.

The pivotable outer wall 5 of slot 4 will be called “tessera” in the following description.

If screw 8 is screwed only to tessera 5, the latter can be advantageously pivoted downwards (FIG. 10) so that the slot is opened and the orthodontic wire can be inserted. Then the slot is closed and tessera 4 is returned to its initial position. Under such conditions, the head of screw 8 protrudes out of the outside face of tessera. To lock tessera 5 in the closure position it is sufficient to screw in slightly screw 8 of bracket 1 so that its opposite end engages with thread 7 of side faces 4a of slot 4 at least by one or two leads. For example, if screw 8 has a length which is equal to the thickness of tessera 5 plus one or two leads of thread 7, the locking of the tessera is obtained just screwing in screw 8 until its head is flushing with the outside face of the tessera.

Under such conditions, the disclosed orthodontic bracket 1 provided with screw has generally the features of a passive self-binding bracket (FIG. 5) able to develop reduced or no friction.

According to the finding, the tightening screw 8 causes the wire to be squeezed against the bottom of slot 4. The obtained increase in the friction which opposes the relative sliding of the bracket with respect to the wire does not allow any displacement or sliding of the wire within slot 4 (FIG. 9).

FIG. 2 shows a bracket of the known type in which the orthodontic wire is held in the slot by an elastic member riding on the wire. It is evident that the elastic means causes an undesired friction on the wire that cannot be controlled.

It should be appreciated that an orthodontic bracket able to adjust the amount of friction between wire and bracket is a remarkable advantage under orthodontic therapy. Actually, the increase in the friction between wire and bracket (with or without the wire being blocked within the slot) has, under some clinic conditions, remarkable advantages some of which will be disclosed into detail thereafter.

A first advantage of the orthodontic bracket according to the present invention consists in that it allows a very good control of the clamping. Actually it is possible to select what tooth has to be moved just tightening the screws of all brackets except for that of the tooth which should be displaced. FIG. 11 shows an example in which in order to displace a canine towards the premolars (as shown by the arrow in the figure) screw 8 of bracket 1 secured to the canine is only partially screwed to release the wire within slot 4, while the screws of all other teeth are tightened to block the wire against relative brackets 1.

Under such conditions, the force exerted by elastic member 9 causing the canine to move has the undesired effect of an opposite force tending to move away the first premolar to which the elastic means is connected. Advantageously, all teeth that are blocked by tightening the respective screws 8 form an anchoring unit so that such opposite force is distributed to the whole anchoring unit. Thus, the force applied by elastic member 9 to the first premolar to which it is connected is distributed to all teeth without causing undesired tooth displacements.

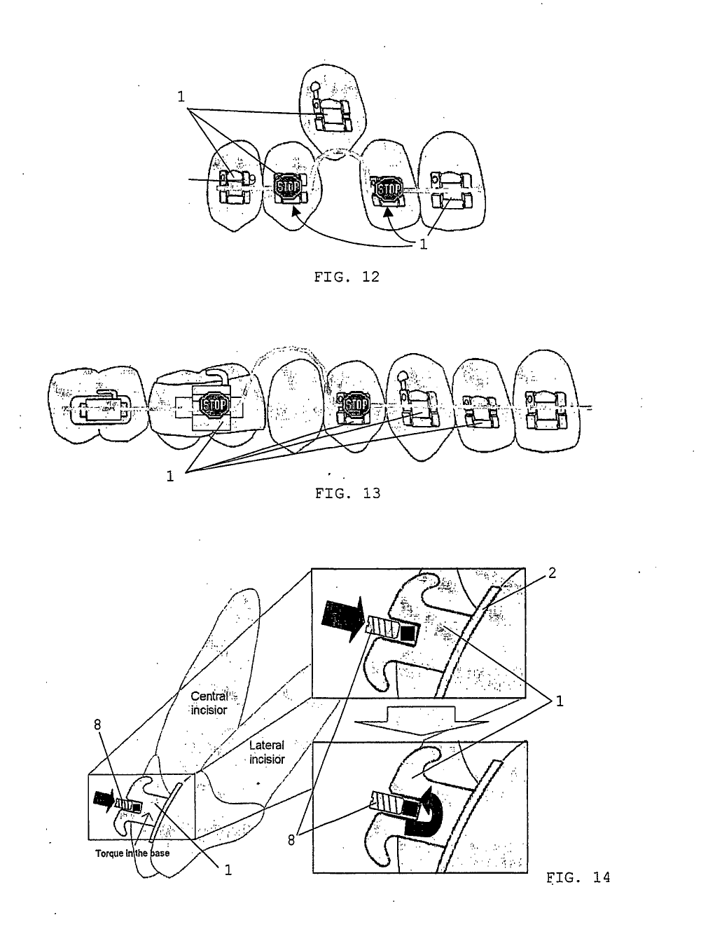

A second advantage of the finding consists in that many auxiliary devices such as the well known clamps and springs which are used at present under conventional orthodontic treatment are superfluous at all. In fact, by using the bracket provided with screw of the present invention, for example, a space between two teeth can be opened without using any spring. FIG. 12 shows the use of a loop of enough elastic wire the ends of which are blocked between two tightened brackets that are secured to teeth to be moved away from each other. In this case, the length of the wire bent to form a loop tends to take the straight shape again, thus applying a force to the teeth engaged by the ends of the loop to move them away from each other.

What disclosed above is also valid to move molars away from one another.

A third advantage of the invention consists in that the device disclosed allows the torque to be completely developed so that the inclination of the slot can influence the inclination of the root of the tooth as the orthodontic wire with square cross section is squeezed against the bottom of slot 4 by tightening screw 8 of bracket 1 (FIG. 14) so that the torque of the orthodontic wire is transmitted to the bracket and then the tooth. To this end, it should be appreciated that in order to adjust the inclination of the root of a tooth, orthodontic wires are used having a square cross section and a particularly large transversal extension with respect to slot 4 so that they engage almost the whole vertical extension of the slot (FIG. 15) and fit precisely the slot to apply the torque giving the tooth a force capable of changing the inclination of the longitudinal axis of the tooth. The present invention achieves the same objects with much thinner wires that are less invasive for the patient.

A fourth advantage of the invention consists in that no auxiliary devices (springs, clamps, etc.) are used, thus reducing the treatment time with a considerable time saving for the medical specialist.

The present invention has been described and illustrated according to a preferred embodiment thereof, however, it is self-evident that those skilled in the art can make technically equivalent modifications and/or replacements without departing from the scope of the present industrial invention.

1. An orthodontic bracket (1) comprising a bracket base (2) able to be secured to the face of a tooth, a body (3) secured to said bracket base (2) and provided with a recess or through slot (4) able to receive an orthodontic wire, and tightening means (8) to block said orthodontic wire within said slot (4), said orthodontic bracket being characterized in that said tightening means (8) is able to perform its function with controlled intensity varying between a maximum value at which said orthodontic wire is blocked within said slot (4) and a minimum value at which said orthodontic wire is completely free to slide within said slot (4).

2. The orthodontic bracket according to claim 1, characterized in that said body (3) includes a moving wall or tessera (5) able to receive said orthodontic wire into said slot (4).

3. The orthodontic bracket according to claim 1, characterized in that said tightening means includes a screw (8) able to cooperate with a screw thread (7) formed in said body (3).

4. The orthodontic bracket according to claim 2, characterized in that said moving wall (5) is hinged at body (3) by a side pin so as to pivot on a plane generally parallel to the bracket base (2).

5. The orthodontic bracket according to claim 2, characterized in said tightening means includes a screw (8) able to cooperate with a screw thread (7) formed in said body (3) and that said screw (8) has a length which is greater than or equal to the thickness of moving wall (5).

6. The orthodontic bracket according to claim 2, characterized in that said tightening means includes a screw (8) able to cooperate with a screw thread (7) formed in said body (3) and the moving wall (5) is provided with a central hole (5a), said screw thread (7) being formed on a surface (5b) of central hole (5a) of tessera (5) and on inner side surface (4a) of slot (4).

7. The orthodontic bracket according to claim 3, characterized in that in order to allow the torque to be completely developed, screw (8) is able to tighten an orthodontic wire having a square cross section by squeezing it against the bottom of slot (4), thus providing that the torque of the orthodontic wire is transmitted to bracket (1) and then the tooth to which it is secured.

8. (canceled)
